(19) United States
(12) Patent Application Publication
(10) Pub. No.: US 2021/0122061 A1
(43) Pub. Date: Apr. 29, 2021

(54) ROTARY TRANSPORT DEVICE FOR A HOLLOW BODY

(71) Applicant: SIDEL PARTICIPATIONS, OCTEVILLE-SUR-MER (FR)

(72) Inventors: Stéphane MORIN, OCTEVILLE-SUR-MER (FR); Pierre HEUZEBROC, OCTEVILLE-SUR-MER (FR); Denis GILLET, OCTEVILLE-SUR-MER (FR); Vincent LECOINTRE, OCTEVILLE-SUR-MER (FR)

(21) Appl. No.: 16/635,791

(22) PCT Filed: Jul. 17, 2018
(86) PCT No.: PCT/FR2018/051816

§ 371 Date: Jan. 31, 2020

(30) Foreign Application Priority Data
Aug. 4, 2017 (FR) 1757538

(51) Int. Cl. B25J 15/00; B65G 19/18; B29C 49/42; B29C 49/64

(52) U.S. Cl. CPC B25J 15/0004; B65G 19/185; B29C 2049/4226; B29C 49/6436; B65G 2201/0247; B29C 49/4205

(57) ABSTRACT

The invention relates to a device for transporting a hollow body provided with a neck, for a hollow body made of a thermoplastic material. The device comprises at least one mounting translatably mobile along a predetermined path, at least one shaft rotatably mounted in the mounting mobile about a predetermined axis, and a member for gripping the hollow body by a neck which is supported by the rotary shaft. The transport device further comprises means for angular indexing of the rotary shaft in a single predetermined indexed angular position in relation to the mounting.

### TECHNICAL FIELD OF THE INVENTION

The invention relates to a transport device for a hollow body equipped with a neck, notably for a hollow body made of a thermoplastic material, which comprises:
at least one support able to move in translation along a determined path;
at least one shaft mounted with the ability to rotate in the support able to move about a determined axis;
a gripper member for gripping the hollow body via a neck, which is borne by the rotary shaft.

### TECHNICAL BACKGROUND OF THE INVENTION

Such transport devices are commonly used in machines for manufacturing containers from thermoplastic preforms, particularly for transporting the thermoplastic preforms through a heating station.

Such preforms are generally obtained by injection molding and have a tubular cylindrical body closed at one of its axial ends, and which is extended at its other end by a neck, likewise tubular. The neck is generally injection molded in such a way as to already have its definitive shape, whereas the body of the preform is intended to undergo a relatively significant amount of deformation in order to form the final container after a shaping operation, notably employing blow-molding.

A final container is crested by forming the preform in a mold. The operation of forming the body of the preform requires this body to be raised to a temperature above the glass transition temperature of the material of which it is made. The thermal conditioning of the preform is carried out in the heating station.

For this purpose, the Seating station comprises a heating tunnel along which are distributed heating means that emit heating radiation, such as infrared lamps. The gripper member moves the preforms along a heating path which passes through this heating tunnel in order to expose the preforms to the heating radiation.

In order for the body of the preform to be heated uniformly it is known practice to confer upon the gripper member its own rotational movement so that the preform rotates about an axis that passes through its neck while following the path. The gripper member is, for example, a mandrel which is forcibly introduced into the neck, or else a chuck which grasps the neck via its external wall.

In known transport devices, the gripper member is driven in its rotation by mechanical drive means of the rack-and-pinion type. The gripper member rotates as one with a pinion. As the gripper member moves along its path the pinion meshes with a fixed rack which extends along the path of the gripper member in the heating tunnel and thus allows the gripper member to be made to rotate on itself at a rotational speed that is proportional to the speed of travel of the chuck or mandrel support along the path.

In order to produce containers that are axisymmetric, the body of the preform is generally heated uniformly. In that case, there is no need to index the angular position of the chuck or mandrel with respect to its support.

However, when the containers, notably bottles, that are to be produced have a transverse cross section that does not exhibit approximate symmetry of revolution about the axis of the neck from the preform stage, the uniform heating of the body of the preform runs into numerous difficulties which are cited for example in document FR-A1-2.703.944.

In order to obtain, by blow-molding or stretch-blow-molding, with a uniform wall thickness, a container the cross section of which does not exhibit symmetry of revolution, it is known practice to heat first portions of the body of the preform to a temperature above the glass transition temperature, without, however, reaching the crystallization temperature of the material. Second portions of the preform are heated beyond the glass transition temperature but to a temperature that is not as high as the portions that are to be overheated. The portions generally take the form of axial strips covering a determined angular sector about the axis of the preform. The distribution of the various parts that are to be heated and the temperature thereof, is usually referred to as the “heating profile”.

Such a method, commonly referred to as the “preferential heating method”, allows the hotter first portions to be given mechanical properties that allow for stretching, notably circumferential stretching, that is more rapid by comparison with the colder second portions.

Furthermore, the heating profile is generally oriented with respect to a determined frame of reference of the container in order to allow the heating profile to be aligned with the shape of the container that is to be obtained when the hot preform is inserted into the mold. Such a point of reference is formed for example of a notch or a peg on the neck of the preform.

When the gripper members are driven in rotation by mechanical drive means such as a rack-and-pinion connection, the angular position of the preform is determined by its location along its path. It is easy to calculate the angular position that a preform will occupy relative to its support according to the number of teeth on the pinion and the pitch between the teeth on the rack. Thus, the heating means are distributed along the path in such a way as to heat the body according to the angular position of the gripper member.

However, the pinion for each gripper member bearing a preform is not permanently engaged with the rack. This is notably the case in the following two configurations which are provided by way of nonlimiting examples which may be combined.

The first configuration arises when the rack takes the form of a chain the tension of which is adjustable. The chain is generally produced as at least two open sections. One end of each of the chain sections is equipped with means for adjusting the tension. The two sections are both arranged along an associated portion of the path of the gripper members in the heating tunnel. As the gripper member crosses the gap between a first chain section and the next chain section, the body of the preform has already begun to be heated according to the desired heating profile. However, in this gap, the pinion is no longer in mesh with either of the two chain sections, and the gripper member is therefore free to rotate about its axis without any control. If the rotation of the gripper member is not controlled, there is a risk that the continued heating of the body of the preform will be according to a heating profile that is angularly offset from the heating profile begun in the first chain section.

The second configuration arises when the heating station is designed to heat the preforms neck down. Because hot air is not as dense as cold air, the neck of the preform is thus easier to keep cool. The cold preforms are conveyed to the station by preform transporting means arranged upstream and the hot preforms are taken up by transport means downstream of the heating station. Now, these upstream and downstream transport means are designed to transport the preforms neck up. Thus, these heating stations are equipped with inverting portions which allow the gripper members to be tilted at the entrance and at the exit of the heating tunnel. In these inverting portions, the pinion is not in mesh with the rack either, and the gripper members are free to rotate about their axis. Now, if the rotation of the gripper member is not controlled, there is a risk that the body of the preform will be heated at a random angular offset from its reference.

In the known transport devices, the gripper members are borne by a shaft which is mounted with the ability to rotate on a support by plain bearings. These plain bearings have a coefficient of friction that makes it possible to slow the rotation of the shaft that bears the gripper member. The coefficient of friction is notably high enough to almost immediately interrupt the rotation of the shaft with respect to its support when the pinion is no longer in mesh with the rack. Thus, the orientation of the preform is more or less maintained when the gripper member undergoes an inverting movement and/or when it crosses the gap between two rack sections. The rotation of the gripper member is thus controlled by this slowing action.

However, these plain bearings require a great deal of maintenance. It is notably necessary to replace them very frequently. Such a plain bearing effectively has a relatively short life, for example of 6000 hours.

To overcome these problems, it is now known practice to guide the rotation of the shaft using rolling bearings, such as ball bearings. Rolling bearings have the advantage of requiring less maintenance by comparison with plain bearings. They also have a considerably longer life, for example of the order of 24 000 hours.

However, rolling bearings are unable to slow the rotation of the shaft when the pinion is no longer in mesh with the rack. On the contrary, the rotation of the shaft is slowed only very slightly and the shaft is generally still rotating uncontrollably as the pinion meshes with the next section of rack.

### BRIEF SUMMARY OF THE INVENTION

The invention proposes a transport device for a hollow body equipped with a neck, notably for a hollow body made of a thermoplastic material, which comprises.
at least one support able to move in translation along a determined path;
at least one shaft mounted with the ability to rotate in the support able to move about a determined axis;
a gripper member for gripping the hollow body via a neck, which is borne by the rotary shaft;

characterized in that the transport device comprises indexing means for angularly indexing the rotary shaft in a unique determined indexed angular position with respect to the support and in that the indexing means comprise at least one pair of magnetic elements, a first magnetic element being fixedly mounted on the shaft and the second magnetic element being fixedly mounted on the support.

According to other features of the invention:
the two magnetic elements of the pair face one another when the shaft is occupying its indexed angular position and are at a sufficiently short distance from one another that they mutually attract;
one of the magnetic elements of the pair is formed by a first permanent magnet which has an exposed pole of determined polarity and which faces toward the other of the magnetic elements when the shaft is occupying its indexed angular position;
the other of the magnetic elements of at least one pair is formed by a ferromagnetic piece;
the other of the magnetic elements of the pair is formed by a second permanent magnet, the second permanent magnet having an attractive pole of opposite polarity to that of the exposed pole of the first permanent magnet, the attractive pole being oriented toward the exposed pole when the shaft is in its indexed angular position;
of the support and the shaft, the one that bears the other of the magnetic elements of the pair comprises a permanent magnet which has a repulsive pole of the same polarity as the exposed pole of the first permanent magnet, the repulsive pole being circumferentially offset with respect to the other magnetic element of the pair so as to face the exposed pole of the first permanent magnet when the shaft is occupying a determined angular position distinct from the indexed angular position, so as to cause the shaft to rotate toward its indexed position by magnetically repelling the exposed pole of the first magnetic magnet;
the repulsive pole is circumferentially offset by 180° about the axis of rotation of the shaft with respect to the other of the two magnetic elements;
the second permanent magnet is arranged on the shaft, and in that the two magnetic poles of the second permanent magnet respectively form the attractive pole and the repulsive pole;
the repulsive pole is created by means of a third permanent magnet;
the magnetic elements of the pair are oriented facing radially toward one another when the shaft is occupying its indexed angular position;
the shaft is guided in rotation in the support by rolling bearings.

### BRIEF DESCRIPTION OF THE FIGURES

Further features and advantages of the invention will become apparent during the course of reading the detailed description which will follow, for an understanding of which reference will be made to the attached drawings in which:

FIG. 1 is a perspective view depicting a device for transporting hollow bodies which is produced according to the teachings of the invention;

FIG. 2 is a view in axial section of the transport device of FIG. 1, depicting a first embodiment of the invention;

FIG. 3 is a view in transverse section on the plane of section 3-3 of FIG. 2, in which a rotary shaft of the transport device is occupying an active positioning with respect to its support;

FIG. 4 is a view similar to that of FIG. 3 depicting an alternative form of the first embodiment of the invention;

FIG. 5 is a view similar to that of FIG. 3 depicting a second embodiment of the invention.

FIG. 6 is a view similar to that of FIG. 3 depicting a third embodiment of the invention.

### DETAILED DESCRIPTION OF THE FIGURES

In the remainder of the description, elements exhibiting elements of identical structure or having analogous functions will be denoted by the same references.

The remainder of the description will adopt, nonlimitingly, by way of orientations:
longitudinal “L” directed from back to front in the direction of travel of mobile supports moving along their path;
vertical “V” directed from the bottom upward, parallel to the main axis of the rotary shaft;
transverse “T” directed from left to right orthogonal to the longitudinal and vertical orientations.

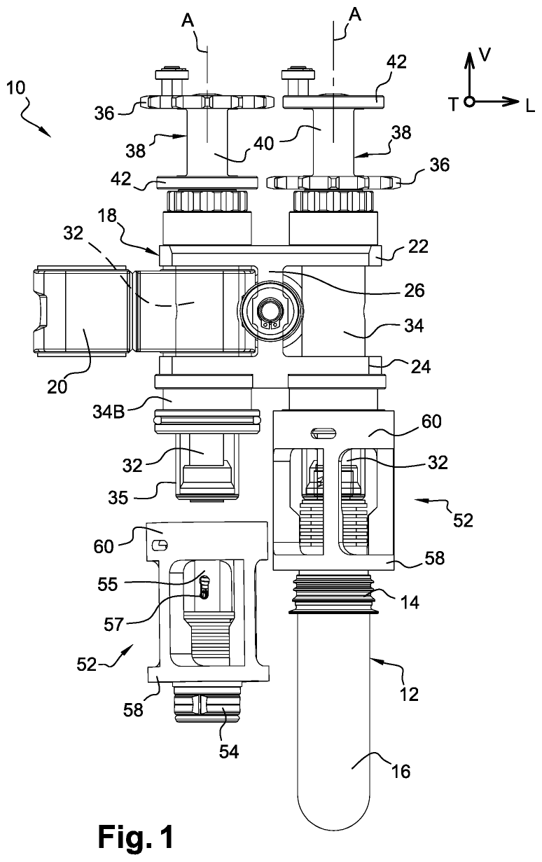

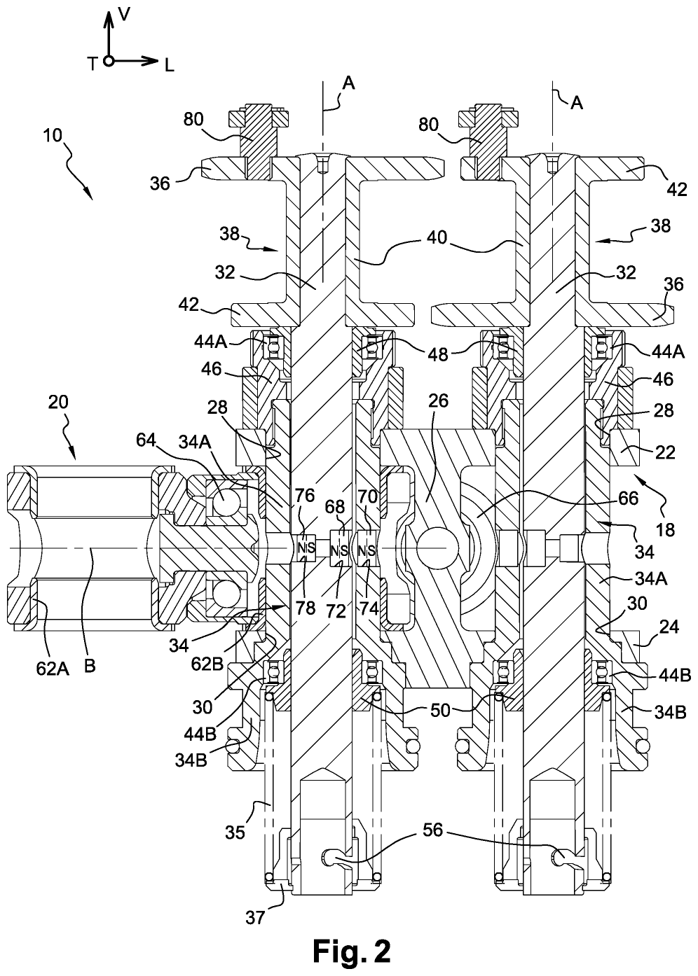

FIGS. 1 and 2 depict a transport device 10 for a hollow body 12 equipped with a neck 14, notably for a hollow body made of a thermoplastic material.

The hollow body 12 here is formed by a preform made of thermoplastics material. It has a tubular cylindrical body 16 of vertical axis “A”. The body 16 is closed at its lower axial end, and is extended at its upper axial end by the neck 14, likewise tubular.

The transport device 10 here is intended to equip a heating station (not depicted) of an installation for the manufacture of containers from such preforms 12 by blow molding.

The device 10 comprises at least one support 18 able to move in translation along a determined path along a heating tunnel of the heating station. The mobile support 18 here is intended to be articulated to other identical mobile supports via articulating links 20 to form a closed transport chain.

As an alternative which has not been depicted, the transport device (10) for a hollow body (12) equipped with a neck, notably for a hollow body made of a thermoplastics material, comprises at least one mobile support (18) formed by a stator of a linear motor, also referred to as shuttle, said support (18) is able to move along a determined path, formed by a linear-motor stator. The stator forms a closed-loop circuit in which the shuttles are able to circulate. The circuit extends in the one same horizontal plane.

In this embodiment described hereinabove, each shuttle is commanded for movement individually, namely independently one shuttle from the others.

The mobile support 18 here has a horizontal upper plate 22 and a horizontal lower plate 24 which are connected by a transverse vertical central web 26. The plates 22, 24 are each pierced with two orifices 28, 30. Each orifice 28 of the upper plate 22 coincides vertically with an orifice 30 of the tower plate 24.

The support 18 here is intended to bear two hollow bodies 12, each via gripping means able to rotate the hollow body about its main axis. Such a rotating gripper means is generally referred to by those skilled in the art as a “turner”.

Each turner comprises a shaft 32 mounted with the ability to rotate in the support 18 able to move about a determined vertical axis “A”. Each shaft 32 is housed rotationally in the associated coincident orifices 28, 30 of the support 18.

The two shafts 32 are arranged on the support 18 in similar ways. This being the case, the layout of just one shaft 32 is described hereinafter, this layout being applicable to the other shaft 32.

A sleeve 34 is interposed radially between each shaft 32 and the support 18. Each sleeve 34 is mounted fixedly with respect to the support 18, whereas the shaft 32 is mounted with the ability to rotate and to slide axially in the sleeve 34.

The sleeve 34 has a tubular upper section 34A of substantially constant diameter which passes through the two orifices 28, 30 and a lower section 34B forming a downwardly widening skirt. The lower section 34B extends below the lower plate 24 of the support 18. A functional radial space that allows the shaft 32 to rotate in the sleeve 34 is provided between an internal wall of the tubular section 34A and a cylindrical external face of the shaft 32.

At an upper end, the shaft 32 is provided with a pinion 36, that rotates as one therewith. The pinion 36 is incorporated into a spool-shaped end piece 38 which comprises a barrel 40 at one axial end of which the pinion 36 extends and, opposite that, a flange 42 of a diameter smaller than that of the pinion 36. The pinion 36 is intended to mesh with a rack (not depicted) which extends along the heating station, so as to drive the shaft 32 in rotation. The end piece 38 is also mounted so that it moves as one with the shaft 32 in terms of axial sliding.

Each shaft 32 is guided in rotation with respect to the support 18 by an upper rolling bearing 44A and by a lower rolling bearing 44B. In this instance these are ball bearings. The shaft 32 here is guided in rotation with respect to the support 18 only by rolling bearings. Each rolling bearing 44A, 44B comprises an outer race which is mounted fixedly with respect to the support 18 and an inner race which is mounted with the ability to slide axially with respect to the shaft 32.

More specifically, the outer race of each upper rolling bearing 44A is mounted in a nut 46 which is fixed to the support 18. The inner race is mounted tightly on a bushing 48 in which the shaft 32 is guided in axial sliding.

Likewise, the outer race of each lower rolling bearing 44B is mounted tightly in the lower section 34B of the sleeve 34. The inner race is mounted tightly on a bushing 50 in which the shaft 32 is guided in axial sliding.

The shaft 32 is mounted with the ability to slide axially between an active positioning depicted in FIGS. 1 and 2, and an inactive positioning (not depicted) in which it has been slid upward, with reference to FIGS. 1 and 2, with respect to its active positioning. It is returned elastically toward its active positioning by an elastic member, in this instance a helical spring 35 which is interposed between a lower spring cup 37, which is fixed to a lower end of the shaft 32, and the bushing 50.

The shaft 32 is intended to bear at its lower end a removable tip 52, referred to as the “turner tip”. Such a tip 52 is already known and will be described briefly with reference to FIG. 1.

The tip 52 at its lower end comprises a gripper member 54 for gripping the hollow body 12 via its neck 14. The gripper member 54 here is a mandrel which is provided with elastic means (not depicted) such as an O ring, advantageously made from an elastic material (such as an elastomer) and the outside diameter of which is equal to or slightly greater than the inside diameter of the neck 14 so that the preform 12 can be lifted by friction against the internal wall of the neck 14 when the mandrel, which forms the gripper member 54, is inserted into the neck 14. The gripper member 54 here is mounted coaxial with the shaft 32.

The gripper member 54 is intended to be mounted fixedly on the shaft 32 via quick-fix means. Here these are means that provide fixing by elastic interconnection of complementing shapes such as bayonet fixing means or ball fixing means. For this purpose, the gripper member 54 is fixed to the lower end of a rod 55 equipped with first quick-fix means 57. The lower end of the shaft 32 comprises complementary second quick-fix means 56. In the example depicted in FIGS. 1 and 2, the tip 52 comprises radial bayonet-fixing studs 57 and the shaft comprises associated notches 56.

The tip 52 further comprises an extraction plate 58 which is mounted with the ability to slide axially with respect to the gripper member 54. The extraction plate 58 has a central passage that allows the gripper member 54 to pass underneath the plate 58 in the active positioning of the shaft 32, and above the plate 58 in the inactive positioning of the shaft 32. The plate 58 is fixed to the lower section 34B of the sleeve 34 by axial interfitting, with an upper ring 60 which is fixed above the plate 58. The plate 58 is intended to bear against an upper edge of the neck 14 of the hollow body 12 when the gripper member 54 is moved upward so as to allow it to be extracted from the neck 14.

Furthermore, two consecutive supports 18 of the transport device 10 are articulated to one another via articulation links 20. Each articulation link 20 comprises an upstream first bearing 62A and a downstream second bearing 62B. In this instance these are plain bearings 62A, 62B. As depicted in FIG. 2, the tubular section 34A of the sleeve of the shaft 32, which is situated upstream on the support 18, is housed with the ability to pivot about its axis “A” in the downstream bearing 62B of the articulation link 20. Likewise, the bearing 62A of the articulation link 20 is intended to accept the tubular section of the sleeve of a shaft situated downstream on the previous support 18. Thus, the transport device 10 forms a closed flexible chain which is made up of an alternation of supports 18 and of articulation links 20, each support 18 being mounted with the ability to pivot about the axis “A” of the upstream shaft 32 associated with the previous articulation link 20.

Here then is a transport device 10 which is intended to be fitted to a heating station designed to heat the hollow bodies 12 with their neck 14 down. For that purpose, the bearings 62A, 62B of each articulation link 20 are mounted with the ability to pivot relative to one another about a longitudinal axis “B” referred to as the “roll axis”. The pivoting of the bearings 62A, 62B in roll relative to one another is guided here by a rolling bearing 64. In this instance it is an angular-contact ball bearing, the axis of rotation of the balls being inclined so as to converge to the front in the direction of travel of the supports 18.

This setup allows the supports 18 to be tilted between the following two angular orientations in roll:
an orientation for the transfer of the hollow bodies 12, in which orientation the axis “A” of the shaft 32 extends vertically such that the gripper member 54 is arranged toward the bottom; and
an orientation for heating the hollow bodies 12, in which orientation the axis “A” of the shaft 32 extends vertically so that the gripper member 54 is arranged toward the top.

The supports 18 are commanded to move between these two orientations in roll by a cam follower 66 which is intended to collaborate by contact with a helical-cam section (not depicted) arranged along the path of the supports 18. The cam follower 66 here takes the form of a roller mounted with the ability to rotate about a transverse axis on the web 26 of the support 18.

Prior to use of the transport device 10, the tip 52 is mounted at the lower end of the shaft 32.

During a cycle of use of the transport device 10, the support 18 first of all occupies its transfer orientation. The shaft 32 is slid toward its inactive positioning by means of a fork (not depicted) which is housed between the pinion 36 and the flange 42 of the end piece 38. The shaft 32 slides against the action of the elastic force of the spring 35, the gripper member 54 moving axially in concert with the shaft 32 in its inactive position, while the plate 58 is kept in its fixed axial position on the lower section 34B of the sleeve 34.

The neck 14 of a cold hollow body 12 brought in automatically by the upstream transport means is then arranged axially in line with the gripper member 54. The shaft 32 is then commanded to move to its active positioning so that the gripper member 54 is forcibly inserted into the neck 14 of the hollow body 12.

The support 18 is then tilted toward its heating orientation by a first helical cam section. During this portion of the path, the pinion 36 is not in mesh with a rack.

The support 18 then enters the heating tunnel of the station. The pinion 36 here is in mesh with a rack (not depicted) to drive the shaft 32, the gripper member 54 and the hollow body 12 in rotation about the axis “A” at an angular velocity that is dependent on the speed of longitudinal travel of the support 18.

In the heating tunnel, the support 18 next crosses a gap separating two rack sections. During this crossing, the pinion 36 is not in mesh with the rack.

The support 18 then continues on its path in such a way that its pinion 36 once again meshes with a subsequent section of rack along the heating tunnel.

On leaving the heating tunnel, the support 18 is tilted into its transfer orientation by a second helical cam section. After exiting the heating tunnel, the pinion 36 is no longer in mesh with a rack. On reaching a heating station exit point, the hot hollow body 12 is taken over by the downstream transport means and the shaft 32 is commanded to move to its inactive positioning so that the gripper member 54 can be extracted from the neck 14 of the hollow body 12.

The cycle is then repeated.

When the support 18 is moving along the portion of path in which the pinion 36 is not in mesh with a rack, the rotary shaft 32 is free to rotate about its axis “A”. For certain applications, notably for preferential-heating methods, it is necessary to control the angular orientation of the hollow bodies 12 about their axis “A” between their entering the heating station up to the point of their blow-molding operation.

To do that, the invention proposes a transport device 10 which comprises means for the angular indexing of the rotary shaft 32 in a unique determined indexed angular position about their axis “A” with respect to the support 18. These indexing means allow the rotary shafts 32 to be returned automatically to their indexed angular position when the pinion 36 of the shaft is not in mesh with a rack and is occupying its active positioning in which the gripper member 54 is liable to be bearing a hollow body 12.

Advantageously, these are contactless indexing means such as magnetic indexing means. This then makes it possible to avoid them wearing, and reduce their maintenance. Such contactless indexing means also carry no risk of being damaged and their life is very long.

The indexing means here comprise at least one pair of magnetic elements. A first magnetic element 68 is mounted fixedly on the shaft 32 and a second magnetic element 70 is mounted fixedly with respect to the support 18. The two magnetic elements 68, 70 of the pair are arranged in such a way as to face one another when the shaft 32 is occupying its indexed angular position and when it is occupying its active positioning with respect to the support 18.

In this indexed angular position, the magnetic elements 68, 70 of the pair are arranged at a sufficiently small distance from one another that they mutually attract. The magnetic attraction between the two magnetic elements 68, 70 is enough to halt the rotation of the shaft 32 in its indexed angular position.

At least one of the magnetic elements 68, 70 of the pair is formed by a first permanent magnet which has an exposed pole of determined polarity which faces toward the other of the magnetic elements 70, 68 when the shaft 32 is occupying its indexed angular position.

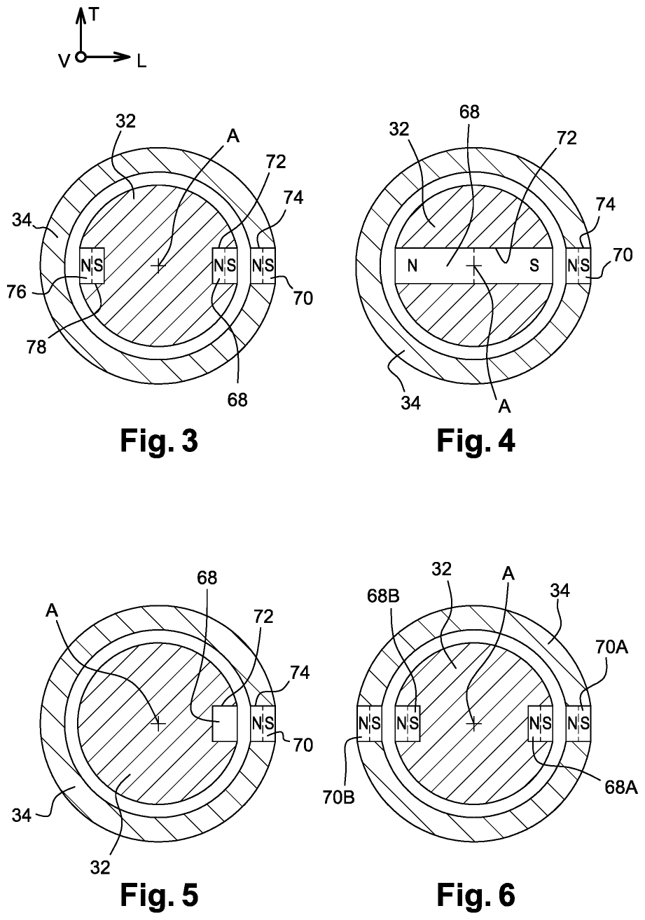

According to a first embodiment of the invention, which is depicted in FIGS. 2 and 3, a single pair of magnetic elements 68, 70 is arranged on each turner.

Each magnetic element 68, 70 of the pair is formed of a permanent magnet. Each magnetic element 68, 70 thus has two magnetic poles of opposite polarity: a first magnetic pole referred to as the “north pole”, which will be indicated by the letter “N” in the figures, and a second magnetic pole referred to as the “south pole”, which will be indicated by the letter “S” in the figures. The north and south poles in each magnetic element 68, 70 are aligned along an axis which will be referred to hereinafter as the “magnetic axis”.

The first magnetic element 68 is fixed in a housing 72 of the shaft 32 which has an opening opening radially to the outside. The first magnetic element 68 is, for example, bonded into the closed end of the housing 72 or else forcibly pushed into the housing 72.

The first magnetic element 68 is arranged here in such a way that its magnetic axis is arranged radially with respect to the axis “A” of the shaft 32. In the embodiment depicted in FIGS. 2 and 3, the south pole of the first magnetic element 68 forms the exposed pole which faces radially toward the outside of the housing 72.

The second magnetic element 70 is fixed in a housing 74 which opens at least radially toward the axis “A” of the corresponding shaft 32. In this instance, the housing 74 passes radially through the cylindrical wall of the tubular section 34A of the sleeve 34. The second magnetic element 70 is for example bonded into the housing 74 or else forcibly inserted into the housing 74.
The second magnetic element 70 is arranged here in such a way that its magnetic axis is arranged radially with respect to the axis “A” of the shaft 32. In the embodiment depicted in FIGS. 2 and 3, the north pole of the second magnetic element 70 forms the exposed pole which faces radially toward the axis “A” of the shaft 32.

The two magnetic elements 68, 70 of the pair are arranged at the same height when the shaft 32 is occupying its active positioning. When the shaft 32 is in the indexed angular position, the first magnetic element 68 is thus radially facing the second magnetic element 70. In this position, the two magnetic elements 68, 70 are separated more or less by the functional radial space left between the shaft 32 and the sleeve 34.

When the shaft 32 is turning freely with respect to the support 18, the first magnetic element 68 attracts the second magnetic element 70 when these are facing one another. If the rotational speed of the shaft 32 is low enough, the force of magnetic attraction immediately interrupts the rotation of the shaft 32 to block said shaft in its indexed angular position. If the rotational speed of the shaft 32 is high, the rotation of the shaft 32 will be slowed by the force of magnetic attraction between the two magnetic elements 68, 70. The shaft 32 might thus oscillate, with damping, on either side of the indexed angular position before stabilizing in its indexed angular position.

Such magnetic indexing means are more particularly effective when the magnetic elements 68, 70 are arranged in a vertical section formed by nonmagnetic components. In the examples depicted in the figures, the rotary shaft 32 is made entirely from a nonmagnetic material, such as aluminum or stainless steel. Likewise, the second magnetic element 70 is borne by the sleeve 34 which is made of a nonmagnetic material such as aluminum, stainless steel or plastic.

It may happen that the shaft 32 stops in a non-indexed angular position in which the magnetic elements 68, 70 of the pair are outside of their zones of mutual influence. This is what happens for example when the shaft 32 has rotated through 180° with respect to its indexed angular position about the axis “A”.

In order to prevent the shaft 32 from remaining in this non-indexed angular position, the invention proposes that of the support 18 and the shaft 32, one should comprise a third permanent magnet 76 which has a repulsive pole of the same polarity as the exposed pole of the permanent magnet borne by the other of the elements that are the support 18 and the shaft 32.

The indexing means are equipped with a single repulsive pole so as to prevent the shaft 32 from becoming blocked in a non-indexed angular position.

In the embodiment depicted in FIGS. 2 and 3, the third permanent magnet 76 is borne by the shaft 32. It is fixed in a housing 78 having an opening opening radially to the outside. The third permanent magnet 76 is for example bonded into the closed end of the housing 78 or else forcibly inserted into the housing 78.

The third permanent magnet 76 here is arranged in such a way that its magnetic axis is arranged radially with respect to the axis “A” of the shaft 32. In the embodiment depicted in FIGS. 2 and 3, the north pole of the third permanent magnet 76 forms the repulsive pole which faces radially toward the axis “A” of the shaft 32.

The exposed pole of the third permanent magnet 76 has the same polarity as the exposed pole of the second magnetic element 70. Said exposed pole of the third permanent magnet 76 thus forms a repulsive pole with respect to the exposed pole of the second magnetic element 70.

The repulsive pole of the third permanent magnet 76 is circumferentially offset from the exposed pole of the first magnetic element 68 of the pair, so as to come to face the exposed pole of the second magnetic element 70 when the shaft is occupying a determined angular position about its axis “A” that is distinct from the indexed angular position. Thus, the force of magnetic repulsion causes the shaft to rotate toward its indexed angular position.

In the embodiment depicted in FIGS. 2 and 3, the repulsive pole of the third permanent magnet 76 is offset by 180° with respect to the exposed pole of the first magnetic element 68. For this reason, the openings of the associated housings 72, 78 of the shaft 32 are arranged diametrically opposite each other at the same height. This arrangement is the most effective at preventing the shaft 32 from finding itself stopped in an unindexed angular position with respect to the support 18.

Thus, the shaft 32 has two exposed poles which are arranged at the same height but circumferentially offset from one another. The exposed pole of the first magnetic element 68 is an attractive pole of opposite polarity to that of the exposed pole of the second magnetic element 70, while the exposed pole of the third permanent magnet 76 forms a repulsive pole of the same polarity as that of the exposed pole of the second magnetic element 70.

It will be noted that the attractive pole and the repulsive pole of the shaft 32 both have opposite polarity.

In this exemplary embodiment, the third permanent magnet 76 has a magnetic flux density lower than that of the permanent magnet that forms the first magnetic element 68. Thus, the intensity of the force of magnetic repulsion produced by the interaction between the third permanent magnet 76 and the second magnetic element 70 is lower, in terms of absolute value, than the intensity of the force of magnetic attraction produced by the interaction between the first magnetic element 68 and the second magnetic element 70. This feature makes it possible notably to reduce any jerkiness that may be observed as the shaft 32 driven by the pinion 36 rotates and which may be caused by the presence of the magnetic indexing means.

Furthermore, in order to ensure that the shaft 32 does not remain blocked in an unindexed angular position, for example at plus or minus 90° from its indexed angular position, mechanical means for reinstating the rotation of the shaft 32 with respect to the support 18 before its pinion 36 engages with the rack have been provided. These means comprise a vertical finger 80 which extends vertically as an upward projection from whichever one, out of the flange 42 and the pinion 36, is the one arranged at the upper end of the end piece 38. The finger 80 is eccentric with respect to the axis “A” of the shaft 32. In this instance, its eccentricity is longitudinally toward the rear when the shaft 32 is occupying its indexed angular position.

Rails (not depicted) are arranged along portions of the path of the supports 18, which portions are located directly upstream of the points at which the pinion 36 begins to mesh with a rack. More particularly, two rails are arranged on either side of each of said path portions. The rails are arranged so that they are convergent in the direction of travel of the supports 18. The closer-together end of the two rails is sufficiently widely spaced that it allows the finger 80 to pass without striking it if the shaft 32 is occupying an angular position close to its indexed angular position, for example within plus or minus 45° of the indexed angular position.

By contrast, when the shaft 32 is occupying an angular position very far removed from its indexed angular position, for example a position 90° away from its indexed angular position, in one direction or the other, the finger 80 strikes one of the rails. This causes the shaft 32 to rotate in the direction of its indexed angular position in which it can be halted by the indexing means before the pinion 36 meshes with the rack.

In the example depicted in the figures, the magnetic elements 68, 70 are arranged facing one another in a radial direction with respect to the axis “A” when the shaft 32 is occupying its indexed angular position.

In a non-depicted alternative form of the invention, the elements 68, 70 are arranged in such a way as to face one another axially when the shaft 32 is occupying its indexed angular position.

According to an alternative form of the invention depicted in FIG. 4, the shaft 32 comprises a single permanent magnet which forms the first magnetic element 68. The first magnetic element 68 is then arranged in a housing 72 which passes diametrically through the shaft 32 and has two openings opening out radially in two opposite directions. The two magnetic poles of the first magnetic element 68 are thus exposed. One of the poles of the first magnetic element 68 then forms the attractive pole while the opposite pole forms the repulsive pole with respect to the exposed pole of the second magnetic element 70. In that case, the intensities of the magnetic forces of repulsion and of attraction are equal.

According to a second embodiment of the invention which is depicted in FIG. 5, one of the magnetic elements 68, 70 of the pair is formed by a ferromagnetic piece, while the other of the magnetic elements 68, 70 is formed by a permanent magnet. The two magnetic elements are arranged in such a way that the permanent magnet attracts the ferromagnetic element in the indexed angular position.

In the embodiment depicted in FIG. 5, the first magnetic element 68 is formed by the ferromagnetic piece while the second magnetic element 70 is formed by the permanent magnet. Each of the magnetic elements 68, 70 is arranged in a housing 72, 74 similar to what was described in respect of the first embodiment of the invention.

In a non-depicted alternative form of the invention, it is possible to swap the arrangement of the ferromagnetic piece and of the permanent magnet in order to obtain the same angular indexing effect on the shaft 32. In that case, the first magnetic element will be formed by the permanent magnet while the second magnetic element will be formed by the ferromagnetic piece.

According to another non-depicted alternative form of the invention, it is possible to combine this second embodiment with the arrangement of a repulsive pole on the element bearing the ferromagnetic piece, as in the first embodiment of the invention.

According to a third embodiment of the invention which is depicted in FIG. 6, the indexing means comprise two pairs of the magnetic elements.

The first pair comprises magnetic elements 68A, 70A which are both formed of permanent magnets. The elements 68A, 70A of the first pair are arranged in an identical way to what was described for the first embodiment of the invention. Thus, the two magnetic elements 68A. 70A of the first pair radially face one another when the shaft 32 is in its indexed angular position and in its active positioning.

The second pair comprises magnetic elements 68B, 70B which are also both formed by permanent magnets The magnetic elements 68B, 70B of the second pair are arranged in the same way as those of the first pair, but with a circumferential offset. Here, the offset is by 180°. Thus, the two magnetic elements 68B, 70B of the second pair radially face one another when the shaft 32 is in its indexed angular position and m its active positioning.

The magnetic elements 68A, 68B, 70A, 70B of the two pairs are all arranged at the same height. Thus, the first magnetic elements 68A, 68B of the two pairs are liable to pass radially opposite any one of the two magnetic elements 70A, 70B depending on the angular position of the shaft 32 with respect to the support 18.

Because the indexing means are designed to index the angular position of the shaft 32 in a unique indexed angular position, the exposed poles of the first magnetic elements 68A, 68B have opposite polarities. As a result, the exposed poles of the second magnetic elements 70A, 70B also have opposite polarities. Thus, when each first magnetic element 68A, 68B of a pair is arranged facing a second element 70A, 70B of the other pair, their exposed poles have identical polarities, causing the shaft 32 to rotate by magnetic repulsion toward its indexed angular position.

Whatever the embodiment selected, the permanent magnets are advantageously arranged at a point on the transport device 10 in which the temperature of the magnet is Kept below its Curie temperature, namely the temperature at which it begins to lose its magnetic properties.

The permanent magnets used in the context of the invention are, for example, made from an iron-based alloy.

In the case of a transport device 10 in which the preforms are heated neck down, it has been found that the temperature of the shaft 32 and of the sleeve 34 remained largely below the Curie temperature. A temperature of 70° C. for example has been observed. Now, for iron-based permanent magnets, the Curie temperature is usually of the order of several hundred degrees Celsius.

The invention of course applies to similar transport devices in which the preforms are heated neck up. In that case, the heating tunnel of the station is generally equipped with heat shields which prevent the heat from rising toward the neck, and therefore toward the support. It then follows that such heat shields make it possible to keep the permanent magnets at a sufficiently low temperature to avoid them losing their magnetic properties.

The indexing means thus allow the shafts 32, and therefore the associated gripper member 54, to be indexed in a unique indexed angular position when the shaft 32 is free to turn with respect to the support 18, namely outside the heating tunnel, notably when the preforms are loaded onto and unloaded from the transport device 10, during the inversion of the supports between their two orientations, and when crossing between two rack sections.

When the shaft 32 is occupying its in active positioning, the magnetic elements 68, 70 are no longer at the same height and therefore no longer attract one another. Nevertheless, the shaft 32 is commanded to move into its inactive position by a fork of which the friction against the end piece of the shaft 32 is enough to prevent the shaft 32 from rotating with respect to the support 18. Thus, it is only necessary for the shaft 32 to be in its indexed angular position before and after the loading and unloading operations in order to guarantee its indexed angular position during said operations.

1. A transport device (10) for a hollow body (12) equipped with a neck, notably for a hollow body made of a thermoplastic material, which comprises:
at least one support (18) able to move in translation along a determined path;
at least one shaft (32) mounted with the ability to rotate in the support (18) able to move about a determined axis;
a gripper member (54) for gripping the hollow body (12) via a neck (14). which is borne by the rotary shaft (32);
wherein:
the transport device (10) comprises indexing means for angularly indexing the rotary shaft (32) in a unique determined indexed angular position with respect to the support (18), and
the indexing means comprise at least one pair of magnetic elements (68, 68A, 68B, 70, 70A, 70B), a first magnetic element (68, 68A, 68B) being fixedly mounted on the shaft (32) and the second magnetic element (70, 70A, 70B) being fixedly mounted on the support (18).

2. The transport device (10) as claimed in claim 1, wherein the two magnetic elements (68, 68A, 68B, 70, 70A, 70B) of the pair face one another when the shaft (32) is occupying its indexed angular position and are at a sufficiently short distance from one another that they mutually attract.

3. The transport device (10) as claimed in claim 2, wherein one of the magnetic elements (68, 68A, 68B, 70, 70A, 70B) of the pair is formed by a first permanent magnet which has an exposed pole of determined polarity and which faces toward the other of the magnetic elements (68, 68A, 68B, 70, 70A, 70B) when the shaft (32) is occupying its indexed angular position.

4. The transport device (10) as claimed in claim 3, wherein the other of the magnetic elements (68) of at least one pair is formed by a ferromagnetic piece.

5. The transport device (10) as claimed in claim 3, wherein the other of the magnetic elements (68, 68A, 68B, 70, 70A, 70B) of the pair is formed by a second permanent magnet, the second permanent magnet having an attractive pole of opposite polarity to that of the exposed pole of the first permanent magnet, the attractive pole being oriented toward the exposed pole when the shaft (32) is in its indexed angular position.

6. The transport device (10) as claimed in claim 3, wherein the one of the support (18) and the shaft (32) that bears the other of the magnetic elements (68) of the pair comprises a permanent magnet (76) which has a repulsive pole of the same polarity as the exposed pole of the first permanent magnet (70), the repulsive pole being circumferentially offset with respect to the other magnetic element of the pair so as to face the exposed pole of the first permanent magnet when the shaft (32) is occupying a determined angular position distinct from the indexed angular position, so as to cause the shaft to rotate toward its indexed position by magnetically repelling the exposed pole of the first magnetic magnet.

7. The transport device (10) as claimed in claim 6, wherein the repulsive pole is circumferentially offset by 180° about the axis (A) of rotation of the shaft (32) with respect to the other of the two magnetic elements (68).

8. The transport device (10) as claimed in claim 7, wherein
the other of the magnetic elements (68, 68A, 68B, 70, 70A, 70B) of the pair is formed by a second permanent magnet arranged on the shaft (32),
the second permanent magnet having an attractive pole of opposite polarity to that of the exposed pole of the first permanent magnet, the attractive pole being oriented toward the exposed pole when the shaft (32) is in its indexed angular position, and
the two magnetic poles of the second permanent magnet (68) respectively form the attractive pole and the repulsive pole.

9. The device (10) as claimed in claim 6, wherein the repulsive pole is created by means of a third permanent magnet (76).

10. The device (10) as claimed in claim 1, wherein the magnetic elements (68, 68A, 68B, 70, 70A, 70B) of the pair are oriented facing radially toward one another when the shaft (32) is occupying its indexed angular position.

11. The device (10) as claimed in claim 1, wherein the shaft (32) is guided in rotation in the support by rolling bearings (44A, 44B).

12. The transport device (10) as claimed in claim 4, wherein the one of the support (18) and the shat) (32) that bears the other of the magnetic elements (68) of the pair comprises a permanent magnet (76) which has a repulsive pole of the same polarity as the exposed pole of the first permanent magnet (70), the repulsive pole being circumferentially offset with respect to the other magnetic element of the pair so as to face the exposed pole of the first permanent magnet when the shaft (32) is occupying a determined angular position distinct from the indexed angular position, so as to cause the shaft to rotate toward its indexed position by magnetically repelling the exposed pole of the first magnetic magnet.

13. The transport device (10) as claimed in claim 5, wherein the one of the support (18) and the shaft (32) that bears the other of the magnetic elements (68) of the pair comprises a permanent magnet (76) which has a repulsive pole of the same polarity as the exposed pole of the first permanent magnet (70), the repulsive pole being circumferentially offset with respect to the other magnetic element of the pair so as to face the exposed pole of the first permanent magnet when the shaft (32) is occupying a determined angular position distinct from the indexed angular position, so as to cause the shaft to rotate toward its indexed position by magnetically repelling the exposed pole of the first magnetic magnet.

14. The device (10) as claimed in claim 7, wherein the repulsive pole is created by means of a third permanent magnet (76).

15. The device (10) as claimed in claim 2, wherein the magnetic elements (68, 68A, 68B, 70, 70A, 70B) of the pair are oriented facing radially toward one another when the shaft (32) is occupying its indexed angular position.

16. The device (10) as claimed in claim 2, wherein the shaft (32) is guided in rotation in the support by rolling bearings (44A, 44B).

17. The device (10) as claimed in claim 3. wherein the magnetic elements (68, 68A, 68B, 70, 70A, 70B) of the pair are oriented facing radially toward one another when the shaft (32) is occupying its indexed angular position.

18. The device (10) as claimed in claim 3, wherein the shaft (32) is guided in rotation in the support by rolling bearings (44A, 44B).
